(19) United States
(12) Patent Application Publication
(10) Pub. No.: US 2009/0271690 A1
(43) Pub. Date: Oct. 29, 2009

(54) HANDLING CROSS-DOMAIN WEB SERVICE CALLS

(75) Inventor: Gaston Iglesias, Sydney (AU)

Correspondence Address: Weaver Austin Villeneuve & Sampson - Yahoo!, P.O. BOX 70250, OAKLAND, CA, 94612-0250, US

(73) Assignee: Yahoo! Inc., Sunnyvale, CA (US)

(21) Appl. No.: 12/110,499

(22) Filed: Apr. 28, 2008

(51) Int. Cl. G06F 17/00

(52) U.S. Cl. 715/200

(57) ABSTRACT

Methods and apparatus are described for handling asynchronous web service calls across multiple domains. A JavaScript library provides a framework for handling such requests without being restricted by the “same origin” policy enforced by browsers.

### BACKGROUND OF THE INVENTION

Most browsers operate with a security restriction known as the “same origin” policy which generally prevents a document or script loaded from one “origin” from getting or setting properties of a document from a different “origin,” and thus prevents client machines from accessing data in a single web page from servers which are not on the same domain. The currently ubiquitous implementation of this policy presents an obstacle to simply embedding code in a third party web page which then attempts to access data or content from another domain.

To enable the creation of dynamic and interactive web pages that present content from multiple sources, a variety of techniques for working around the same origin policy have been developed. One such technique works as follows. Normally web service requests using the XMLHttpRequest object run afoul of browser security restrictions that prevent files from being loaded across domains. So, instead of using the XMLHttpRequest API conventionally used in JavaScript for fetching data, standard JavaScript methods are used to dynamically generate a <script> tag to point to a destination address where a target JSON web service is located. This prompts the browser to fetch a JavaScript resource from the specified destination address. In response to the fetch, the web service at the destination address returns JSON-encoded data wrapped in a JavaScript callback function which is defined earlier in the page. The response is loaded and parsed by the browser which executes the callback function that operates on the result. This approach generally works due to the fact that <script> tags are not bound by the same origin policy.

The problem with the workaround specified in [0002] is that the web service responses are loaded into a common JavaScript namespace. As a consequence it is possible for web service responses to become ambiguous if the callback function names in the responses are not unique. For example, if there are multiple calls from a page to one or more web services and responses returned by the web services are wrapped in identically named callback functions then the function may be unable to differentiate between the responses. This is because the requested data is returned in the same format. Thus, when different operations are desired for different responses, the callback in most cases is unable to identify which response it is handling and hence which operation it should perform. Moreover, not being able to disambiguate between responses presents difficulties in determining when a web service call has failed or timed out. This is an important requirement for performing graceful error handling for usability and security purposes. To deal with these issues requires a level of control of the remote web services or intensive customization for each web service which prevents the technique from being sufficiently flexible for widespread use.

### SUMMARY OF THE INVENTION

According to a first class of embodiments of the present invention, methods and apparatus are provided for facilitating presentation of web pages. Web page code representing a web page is caused to be transmitted to a computing device in response to a web page request. The web page code identifies a first domain as a source of the web page. The web page code includes a first script tag referring to a first web service request function included in an externally stored request function library. The first script tag is configured to enable a browser application from which the web page request originated to initiate a first call by the first web service request function to a corresponding first web service, and to render first content returned by the first web service in line with the web page code; wherein the first content originates from a second domain different from the first domain. According to some embodiments, computer program products are provided which include at least one computer-readable medium having the web page code stored therein.

According to another class of embodiments, methods and apparatus are provided for facilitating presentation of web pages. A web page is instantiated with reference to web page code. The web page code identifies a first domain as a source of the web page, and includes a first script tag referring to a first web service request function included in an externally stored request function library. The first web service request function is loaded into the web page code in response to the first script tag. A first call by the first web service request function is initiated to a corresponding first web service. First content returned by the first web service is rendered in line with the web page code; wherein the first content originates from a second domain different from the first domain.

A further understanding of the nature and advantages of the present invention may be realized by reference to the remaining portions of the specification and the drawings.

### BRIEF DESCRIPTION OF THE DRAWINGS

FIG. 1 is a flowchart illustrating operation of a specific embodiment of the invention.

FIG. 2 is an illustration of a web page generated in accordance with a specific embodiment of the invention.

FIG. 3 is a simplified diagram illustrating an example of a computing environment in which embodiments of the present invention may be implemented.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

According to various embodiments of the invention, techniques are provided for handling asynchronous cross-domain web service calls. According to a particular class of embodiments, placeholder script tags are embedded in the html of a web page, and externally hosted JavaScript is loaded within the context of the page. Some background information on enabling technologies for specific embodiments of the invention may be useful.

AJAX (Asynchronous JavaScript and XML), or Ajax, is a group of inter-related web development techniques used for creating interactive web applications. A primary characteristic is the increased responsiveness and interactivity of web pages achieved by exchanging small amounts of data with the server so that entire web pages do not have to be reloaded each time there is a need to fetch data from the server. This is intended to increase the web page's interactivity, speed, functionality and usability. AJAX is a cross-platform technique usable on many different operating systems, computer architectures, and web browsers as it is based on open standards such as JavaScript and the Document Object Model (DOM).

AJAX is asynchronous in that extra data are requested from the server and loaded in the background without interfering with the display and behavior of the existing page. JavaScript is the scripting language in which AJAX function calls are usually made. XML is sometimes used as the format for transferring data between the server and client, although any format will work, including preformatted HTML, plain text and JavaScript Object Notation (JSON).

JSON is a lightweight, text-based, language-independent data interchange format. JSON defines a small set of formatting rules for the portable representation of structured data. Although JSON was based on a subset of the JavaScript programming language and is commonly used with that language, it is considered to be a language-independent data format. For additional information regarding JSON reference can be made to RFC 4627 by Douglas Crockford entitled The application/json Media Type for JavaScript Object Notation (JSON), the entire disclosure of which is incorporated herein by reference for all purposes.

According to one class of embodiments, a JSON request library is provided which is dedicated to the execution and management of AJAX-style, cross-domain asynchronous web service calls. The JSON request library may reside in one or more locations on the Web, e.g., in the Yahoo! network, in publicly available repositories, or even on the server(s) of the site from which web pages containing such script tags are served. The framework described herein may be implemented for use with all of the major browser technologies (e.g., Firefox, Internet Explorer, Opera, and Safari).

A specific implementation will now be described in which an embodiment of the invention is employed for the purpose of including search results from a search service in third-party web pages. It should be noted, however, that the present invention should not be limited with reference to such an implementation. Rather, embodiments of the present invention may be used to effect the incorporation of any type of content from different domains in any web page.

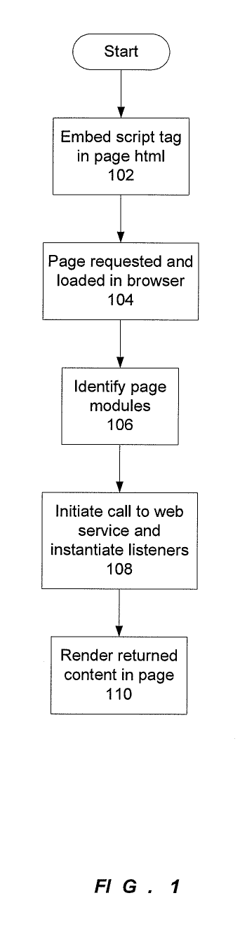

Referring now to FIG. 1, when it is desired to generate a web page which includes content (e.g., search results), from a domain which is different than the domain from which the page is to be served, a script tag is embedded in the html referencing the JSON request library and a JavaScript application specific to this embodiment of this invention (102). When the web page is loaded in a browser (104), a browser event triggers the application which scans through the page to identify locations on the page where modules with search result content are to be presented (106). Prompted by user interaction, or acting upon a default search query, the application iterates through the identified search modules, and attempts to fetch search results using the JSON request library to makes calls to a corresponding web service (108).

According to one implementation, the called web service aggregates search results from a variety of sources. In response to the call, the search results aggregation web service identifies the sources from which search results are to be aggregated, and begins to fetch search results from the different sources. It should be noted that this kind of aggregation is optional, and that the content to be presented in the web page can come directly from the called web service without an aggregation taking place.

When a web service call is returned with the requested data, a listener created by the JSON request library triggers a client-side JavaScript function, specified at the time the web service call is made, and executes a rendering function to render the content in line in the web page (110).

An example of page html using place holders to denote the locations of search result content modules within a page according to a specific embodiment of the invention is provided below. In this example, search results are fetched asynchronously using the JSON request library from three different sources and rendered into the pre-defined locations.

```
<html>
<head>
<link rel=“stylesheet” media=“screen, projection” type=“text/css”
href=“http://w1.feds.aue.yahoo.com/css/alphascript.css” />
</head>
<body>
    <!-- Simple search form -->
    <form name=‘f’>
  <input name=‘p’ type=‘text’ length=‘150’ maxlength=‘200’
value=‘olympics’/>
  <input type=‘submit’ value=‘search’/>
  </form>
    <div id=‘bd’ class=‘cf’>
      <!-- Left hand column -->
      <div id=‘lhc’ class=‘lft’>
        <div>Left Column</div>
        <!-Script tag placeholder for 1st cross-domain content -->
        <div id=‘alphamod0’ class=‘alphamain’></div>
      </div>
      <!-- Right hand column -->
      <div id=‘rhc’ class=‘rgt’>
        <div>Right Column</div>
        <!-Script tag placeholder for 2nd and 3rd cross-domain
        content -->
        <div id=‘alphamod1’></div>
        <div id=‘alphamod2’></div>
      </div>
    </div>
  <!-- A minified JavaScript file containing a distributable search
application which implements the JSON request library -->
  <script type=“text/javascript”
src=“http://w1.feds.aue.yahoo.com/js/alpha-canon-min_js.php”></script>
  <!-- Invocation of application -->
  <script type=“text/javascript” defer=‘true’>
  YAHOO.canon.fire(‘gstar180’);
  </script>
</body>
</html>
```

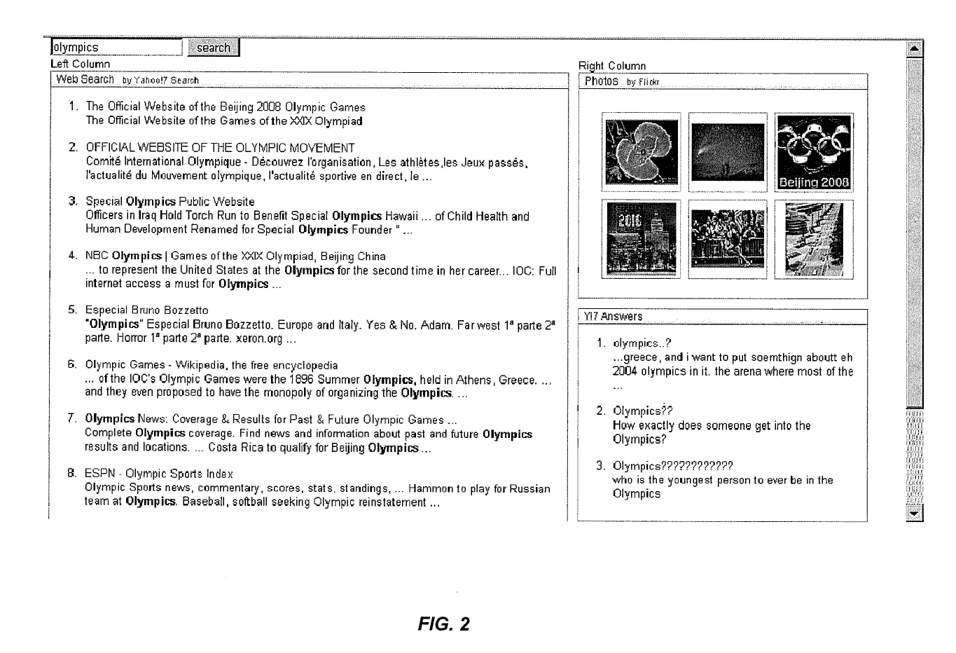

An example of a web page rendered according to such html is shown in FIG. 2. Note the three different sources of the search results.

According to a specific embodiment, the JSON request library is implemented as a JavaScript object. This object exposes a series of functions for use in JavaScript for executing and managing cross-domain JSON requests. The JSON request object is passed details about a request that is to be made including the url of the target web service from which data is to be fetched, and a callback function to operate on the response. Note that this callback (referred hence as callback A) is different to the callback used by the web service to wrap the JSON response (callback B).

The JSON Request object generates a unique Transaction Identifier (TID) for the request and stores a mapping between the new TID and the callback A. The JSON request object then creates a new <iframe> which is appended to the DOM tree and initialized by dynamically generating JavaScript code within the <iframe> to keep track of the TID and to handle the response from a JSON request call. Once the <iframe> has been initialized with the correct parameters, the JSON request call is executed by dynamically generating a script tag inside the <iframe> which is initialized with information about the request's TID. When a response is returned, the callback inside the <iframe>, i.e., callback B, passes the data response and TID to the JSON request object. Using the TID the JSON request object is able to fetch details about the original request that was mapped to this response, including the correct application callback, i.e., callback A, that needs to be used to operate on the results. The application callback, i.e., callback A, is executed and passed the response by the JSON request object.

Using this method we avoid the limitations of the technique described in [0002] as we address the problems of loading external function wrapped JSON resources into a common namespace, by loading each separate JSON request in its own <iframe>, which has it's own namespace effectively “sandboxing” the request, and thus eliminating the possibility of ambiguity upon response. The JSON request object is then able to manage calls using a unique identifier to track the status, and is able to abort, re-try or place timeouts on calls if desired.

According to some embodiments, the web services being accessed are not restricted to services which are configured to respond to JSON requests or provide data in the JSON format. According to such embodiments, an intermediate conversion mechanism may be provided to receive JSON requests from the client side which correspond to non-JSON web services and/or data in other formats (e.g., RSS or OpenSearchRSS), retrieve the requested data, format the retrieved data in the JSON format, and transmit the reformatted data to the browser for presentation. As will be understood, any data which can be converted to or encapsulated with JSON may be dynamically integrated into a web page in accordance with the invention using such a mechanism.

There has been a trend in web page design toward the use of multiple data sources and presentation modules. The JSON request library and framework enabled by the present invention may be leveraged to support this trend, and thus to enable the design of very rich and dynamic web pages to which users of the Web are becoming increasingly accustomed. That is, embodiments of the invention alleviate the need to build customized solutions for each web service used as a source of content in a web page by providing a more universal and flexible approach. Embodiments of the invention also allow for a very high degree of web page customization in that modules which integrate content according to the invention may be placed anywhere on the page; not only anywhere on the page, but with the full range of “look and feel” options available to the web page designer. This is to be contrasted with the use of mechanisms like i-frames that typically do not give the web page designer much if any control over the content rendered in the i-frame.

In addition, specific embodiments of the invention enable functionality which is typically not enabled or available with conventional approaches to this problem. For example, embodiments of the invention are contemplated which are able to measure and respond to request time outs. That is, because of their ad hoc nature, conventional solutions do not typically provide a mechanism by which the client browser can determine or respond to circumstances in which the embedded content was not properly fetched. By contrast, embodiments of the invention include mechanisms, e.g., callback functions maintained by the browser, which enable individual management of each JSON request.

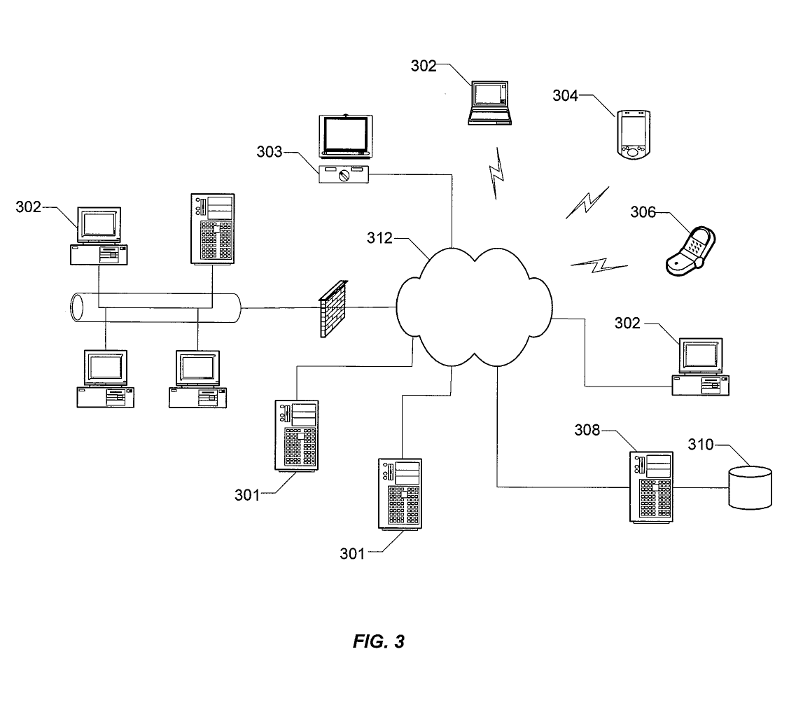

Embodiments of the present invention may be employed to generate and present web pages according to the invention in any of a wide variety of computing contexts. For example, as illustrated in FIG. 3, implementations are contemplated in which a population of users interacts with web sites 301 via a diverse network environment using any type of computer (e.g., desktop, laptop, tablet, etc.) 302, media computing platforms 303 (e.g., cable and satellite set top boxes and digital video recorders), handheld computing devices (e.g., PDAs) 304, cell phones 306, or any other type of computing or communication platform.

As described above, a JavaScript library referenced by script tags in web pages in accordance with the invention may be stored in a centralized manner. This is represented in FIG. 3 by server 308 and data store 310 which, as will be understood, may correspond to multiple distributed devices and data stores. Alternatively, access to such a JavaScript library may be provided in a much more distributed manner, e.g., at individual web sites, or for groups of web sites. The invention may also be practiced in a wide variety of network environments including, for example, TCP/IP-based networks, telecommunications networks, wireless networks, etc. These networks are represented by network 312. Web pages generated in accordance with the invention may then be presented to users via the various channels with which the users interact with the network.

In addition, the computer program instructions and code with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method for facilitating presentation of web pages, comprising causing transmission of web page code representing a web page to a computing device in response to a web page request, the web page code identifying a first domain as a source of the web page, the web page code including a first script tag referring to a first web service request function included in an externally stored request function library, the first script tag being configured to enable a browser application from which the web page request originated to initiate a first call by the first web service request function to a corresponding first web service, and to render first content returned by the first web service in line with the web page code, wherein the first content originates from a second domain different from the first domain.

2. The method of claim 1 wherein the first script tag is further configured to enable the browser to maintain a monitoring function corresponding to the first call by first web service request function.

3. The method of claim 2 wherein the monitoring function is operable to determine whether a response to the first call has been received within a period of time.

4. The method of claim 1 wherein the web page code further includes a second script tag referring to the first web service request function, the second script tag being configured to enable the browser application to initiate a second call by the first web service request function to the first web service, and render second content returned by the first web service in line with the web page code without interfering with rendering of the first content, wherein the second content also originates from the second domain.

5. The method of claim 1 wherein the web page code further includes a second script tag referring to a second web service request function included in the request function library, the second script tag being configured to enable the browser application to initiate a first call by the second web service request function to a corresponding second web service, and render second content returned by the second web service in line with the web page code without interfering with rendering of the first content, wherein the second content originates from a third domain different from the first and second domains.

6. The method of claim 1 wherein the externally stored request function library is associated with the first domain.

7. The method of claim 1 wherein the externally stored request function library is associated with a third domain different from the first and second domains.

8. A computer program product comprising at least one computer-readable medium having web page code stored therein representing a web page, the web page code identifying a first domain as a source of the web page, the web page code including a first script tag referring to a first web service request function included in an externally stored request library, the first script tag being configured to enable a browser application to initiate a first call by the first web service request function to a corresponding first web service, and to render first content returned by the first web service in line with the web page code, wherein the first content originates from a second domain different from the first domain.

9. The computer program product of claim 8 wherein the first script tag is further configured to enable the browser to maintain a monitoring function corresponding to the first call by first web service request function.

10. The computer program product of claim 9 wherein the monitoring function is operable to determine whether a response to the first call has been received within a period of time.

11. The computer program product of claim 8 wherein the web page code further includes a second script tag referring to the first web service request function, the second script tag being configured to enable the browser application to initiate a second call by the first web service request function to the first web service, and render second content returned by the first web service in line with the web page code without interfering with rendering of the first content, wherein the second content also originates from the second domain.

12. The computer program product of claim 8 wherein the web page code further includes a second script tag referring to a second web service request function included in the request function library, the second script tag being configured to enable the browser application to initiate a first call by the second web service request function to a corresponding second web service, and render second content returned by the second web service in line with the web page code without interfering with rendering of the first content, wherein the second content originates from a third domain different from the first and second domains.

13. A computer-implemented method for facilitating presentation of web pages, comprising:
instantiating a web page with reference to web page code, the web page code identifying a first domain as a source of the web page, the web page code including a first script tag referring to a first web service request function included in an externally stored request function library;
loading the first web service request function into the web page code in response to the first script tag;
initiating a first call by the first web service request function to a corresponding first web service; and
rendering first content returned by the first web service in line with the web page code, wherein the first content originates from a second domain different from the first domain.

14. The method of claim 13 further comprising maintaining a monitoring function corresponding to the first call by first web service request function.

15. The method of claim 14 further comprising determining with the monitoring function whether a response to the first call has been received within a period of time.

16. The method of claim 13 wherein the web page code further includes a second script tag referring to the first web service request function, the method further comprising initiating a second call by the first web service request function to the first web service, and rendering second content returned by the first web service in line with the web page code without interfering with rendering of the first content, wherein the second content also originates from the second domain.

17. The method of claim 13 wherein the web page code further includes a second script tag referring to a second web service request function included in the request function library, the method further comprising initiating a first call by the second web service request function to a corresponding second web service, and rendering second content returned by the second web service in line with the web page code without interfering with rendering of the first content, wherein the second content originates from a third domain different from the first and second domains.
